(19) United States
(12) Patent Application Publication
(10) Pub. No.: US 2004/0216241 A1
(43) Pub. Date: Nov. 4, 2004

(54) Emulsifying agent composition and low-fogging, high-exhaust stuffing agent, the production and utilization thereof

(76) Inventors: Gunther Pabst, Mannheim (DE); Andreas Seitz, Birkenheide (DE); Ralph Lunkwitz, Neustadt (DE)

Correspondence Address: Keil & Weinkauf, 1350 Connecticut Avenue NW, Washington, DC, 20036, US

(21) Appl. No.: 10/487,536

(22) PCT Filed: Sep. 6, 2002
(86) PCT No.: PCT/EP02/10017

(30) Foreign Application Priority Data
Sep. 7, 2001 (DE) 101 43 949.0

(51) Int. Cl. C14C 1/00

(52) U.S. Cl. 8/94.15; 8/115.51

(57) ABSTRACT

Disclosed are an emulsifier composition particularly useful for preparing low-fogging, high-exhaust fatliquoring compositions, the thus obtained and preferred fatliquoring compositions and the use of the emulsifier composition and of the fatliquoring compositions in the manufacture of leather.

The present invention relates to an emulsifier composition particularly useful for preparing low-fogging, high-exhaust fatliquoring compositions, the thus obtained fatliquoring compositions and the use of the emulsifier composition and of the fatliquoring compositions in the manufacture of leather and the low-fogging leathers produced.

Fatliquoring agents are used in leather manufacture to soften the leather, to increase its fullness and strength and to protect it against moisture, dirt and outside chemical influences (see H. Herfeld, “Bibliothek des Leders”, vol. 4, (1985), pages 13 ff.). Commercially available fatliquoring agents are products which generally consist of chemically modified native fats, fatty oils, waxes, resins and derivatives thereof and/or petroleum fractions and downstream products thereof (see H. Herfeld, “Bibliothek des Leders”, vol. 4, (1985), pages 59 ff.).

Commercially available fatliquoring agents generally consist of active components, such as native fats, fatty oils, waxes, resins and derivatives thereof and/or petroleum fractions and downstream products thereof, and waxy products such as “wool grease” in crude, purified and/or processed (lanolin) form. The active fatliquor components can if desired be chemically modified, ie have a modified chemical structure.

Fatliquors are usually combinations of unmodified active components known as neutral fats and chemically modified active components.

Active fatliquor components are generally chemically modified by subjecting the double bonds in these materials at least in part to addition or oxidation reactions. Examples of frequently practiced modifications are the addition of sulfites, introducing sulfonic acid groups into the fatty substance, an air oxidation, which introduces oxygen functions and may in some instances also give rise oligomerizations. Other possibilities include the (partial) hydrolysis of the fatty materials, transesterifications and the like modification reactions.

The purpose of these chemical modifications is to optimize the properties of the active fatliquor materials that are relevant to performance, for example hydrophilicity, hydrophobicity, solubility, dispersibility, penetration and attachment characteristics, to specific applications or user requirements.

Partial sulfite addition (construction of sulfonic acid groups) and partial oxidation are of particular importance in commercial practice. The combination of these modifying measures at least makes it possible to influence a whole series of interesting performance characteristics, especially hydrophilicity, penetration power and attachment properties.

The present invention relates to novel leather treatment compositions for manufacturing leathers containing low levels of volatile constituents, especially for high-end automotive upholstery leathers, a process for preparing these compositions and their use in the manufacture of low-fogging leathers. Automotive upholstery leathers have to meet certain criteria. These are essentially softness, fastness to light and heat and also fogging resistance. German standard specification DIN 75201 defines fogging as a condensation of vaporized volatile constituents from the vehicle interior on the glass windows, especially the windshield. The same standard specification describes a gravimetric method and a reflectometric method for characterizing the fogging characteristics of leather.

EP 498634 A2 recommends specific polymers for preparing low-fogging leathers, the aqueous dispersions being substantially free from organic solvents and containing an amphiphilic copolymer formed from a predominant amount of at least one hydrophobic monomer and a lesser amount of at least one hydrophilic monomer. The treatment of leather with these dispersions leads to good results in a gravimetric test to DIN 75201. Reflectometric data are not disclosed.

These amphiphilic copolymers are preferably prepared in aqueous emulsion polymerization. However, owing to the different hydrophilicities of the monomers to be used, this naturally gives rise to problems with the copolymerization characteristics, a possible consequence of which is in the extreme case for the monomers each to form homopolymers, which is not what is wanted. A further consequence of the inherently unfavorable dissolution ratios is the need for a costly reprocessing to destroy residual monomers. To obtain good emulsion stability it is also necessary to add sufficient emulsifier (lauryl sulfate is used in the recited examples), and this can give rise to wastewater problems for the leather processing operation.

EP 466 392 B1 describes a process for preparing a polymer containing both pendant hydrophobic groups and pendant alkoxylated groups by post-polymerization derivatization of polymers obtainable by conventional techniques. Preferably, polymers are prepared from simple monomers such as acrylamide and/or acrylic acid by conventional polymerization and then derivatized using a mixture of primary amines having a hydrophobic radical and primary or secondary alkoxylated amines. The polymers described are used as agents for thickening and soil release.

WO 98/10103 describes a further process for preparing polymeric fatliquoring agents by polymerization of acrylic acid and/or methacrylic acid and/or their acyl chlorides and/or their anhydrides with further copolymerizable water soluble monomers and with copolymerizable water insoluble monomers and subsequent reaction of the polymers with amines. The gavimetric method of DIN 75201 B measured fogging values of 1.2 mg and 1.5 mg for leathers treated with the recited exemplary products; leathers coated with comparative products (Magnopal® SOF, low-fogging polymeric fatliquor, and Chromopol® LFC, low-fogging fatliquor based on fish oils, both from Stockhausen GmbH & Co. KG) give fogging values of 3.9 mg and 3.5 mg. The DIN 75201 A reflectometric values are 51% and 55% for the exemplary products and 34% and 40% for the comparative products.

U.S. Pat. No. 5,348,807 describes a method using selected amphiphilic copolymers consisting of a predominant fraction of hydrophobic units and a lesser fraction of hydrophilic units as solvent-free low-fogging fatliquors. The hydrophilic monomers used for preparing these polymers include acidically or basically substituted esters of unsaturated carboxylic acids, for example sulfatoethyl (meth)acrylate or dimethylaminoethyl(meth)acrylate. Useful hydrophobic monomers include for example long-chain alkenes or (C₄-C₁₂)-alkyl (meth)acrylates or vinyl esters of C₄-C₁₂ carboxylic acids. The substances provide good fogging values; however, no bath exhaustion data are disclosed.

Here too, the amphiphilic copolymers are preferably prepared by aqueous emulsion polymerization. However, owing to the different hydrophilicities of the monomers used, this leads to the same polymerization problems as discussed above in the review of EP-A-498634.

As well as these polymers, EP 0 753 585 B1 describes a low-fogging surface treatment for furniture leather and the method wherein specifically treated native oils, containing less than 3% of fatty acid components of less than 16 carbon atoms, serve as a base for a fatliquoring composition. The native oils used are soybean oil, lard oil, safflower oil and sunflower oil. The native oils mentioned are initially distilled to remove undesirable low molecular weight constituents and are then bisulfited or bisulfated to facilitate emulsification. The (partially) functionalized oils are then emulsified and used.

High-exhaust fatliquors are desirable for ecological reasons. For a fatliquor to provide high exhaustion, it has to be very fully taken up by the collagen. In the case of wet blue intermediate articles, usually anionic fatliquor is fixed by the chromium(III) cations. In the case of wet whites, which are produced without cationic metal salts, these binding sites are absent. The consequence is that commercially available fatliquors, prepared according to the prior art, give poor bath exhaustion, ie the residual float has a high COD value. In the prior art, bath exhaustion is improved by chemical modification of the fatliquor, and generally is accomplished by depositing the fatliquor components on the leather surface. Consequently, the compounds are badly fixed in the leather and so provide leathers having high DIN 75201 fogging values.

The above-described prior art processes all have in common that they employ either polymers or fatliquor ingredients based on chemically modified native oils and that these products represent specific, relatively restricted classes of materials. Moreover, all these processes completely disregard the environmental aspects of maximizing float exhaustion.

It is an object of the present invention to provide a process for fatliquoring leather and a fatliquoring composition free of these disadvantages of the prior art.

We have found that this object is achieved, surprisingly, by the use of a novel emulsifier composition and of a fatliquoring agent mixture of the composition indicated hereinbelow.

Particularly advantageous effects are obtained on using the emulsifiers of the invention in combination with hereinbelow described, specifically modified fatliquoring agents.

The present invention accordingly provides an emulsifier composition comprising three components A, B and C, wherein

said component A is a C₆-C₁₄ alkanol alkoxylated with 4 to 12 AO units, or a mixture of a plurality of such alkanols,

said component B is a C₁₂-C₂₄ fatty alcohol mixture alkoxylated with 15 to 40 AO units, and

said component C is a C₁₂-C₂₄ fatty alcohol mixture alkoxylated with 50 to 100 AO units.

The AO units are conveniently alkylene oxide units having 2 to 4 and preferably 2 or 3 carbon atoms. The building blocks of the polyether chains may all be identical or different and—if they are different—may be randomly distributed or in the form of blocks.

The weight fractions of the components in the emulsifier composition are

for component A: from 20 to 60%, preferably from 25 to 50% and especially from 28 to 40% by weight,

for component B: from 20 to 70%, preferably from 25 to 60% and especially from 30 to 45% by weight, and

for component C: from 10 to 50%, preferably from 15 to 40% and especially from 22 to 32% by weight,

based on the total weight of the composition.

Preferably, the alkoxylated alkanol or alkoxylated alkanol mixture of component A has an average 8 to 12 carbon atoms, especially 10 carbon atoms, the alkoxylated alkanol mixture of components B and C has an average 14 to 20 carbon atoms, especially 16 to 18 carbon atoms.

Preference is further given to emulsifier compositions in which component A has 5 to 10 AO units, component B 20 to 30 AO units and component C50 to 100 AO units.

Alkoxylated long-chain alcohols are known. They are obtained by reacting the corresponding alkanols and alkanol mixtures present in the fatty alcohols with the desired molar quantities of alkylene oxides such as ethylene oxide, propylene oxide or butylene oxide. Depending on how the alkylene oxides are metered into the batches, specifically random or block-type polyether chains can be produced. The reaction can be catalyzed with small amounts of water and/or alkali.

The emulsifier compositions according to the invention are prepared by mixing the components with stirring and if necessary gentle heating.

They can if desired be admixed with water to convert them into solutions which, in accordance with user requirements, conveniently have a solids content of about 40-80% by weight. It will appreciated that other concentrations of the emulsifier compositions according to the invention can be provided as well, for specific purposes.

The invention further provides a fatliquoring composition for leather, comprising one or more, modified or unmodified, native active components and/or optionally a synthetic active component, especially a polymeric active component, emulsifiers and optionally diluents, especially water, containing an emulsifier composition as described above.

Generally, the fatliquoring compositions of the invention contain from 2 to 20% and preferably from 5 to 15% by weight of the emulsifier composition according to the invention.

Particular advantages result on using fatliquoring compositions in which the emulsifier composition according to the invention is combined with a fatliquoring component which comprises at least one neutral oil chemically modified by oxidation and sulfitation in such a way as to combine a relatively high degree of oxidation with a relatively low degree of sulfitation.

Useful neutral oils include in principle all customary native oils containing a sufficient amount of double bonds. The native fatliquoring components used are conveniently fatty materials of vegetable or animal origin, especially glycerides of natural fatty acids having a sufficient fraction of unsaturated acids.

Very useful fatty materials include vegetable and animal fats and oils having an iodine number of from about 10 to about 200. The lower end of this range accommodates for example stearin and tung oil and the upper end especially the fish oils and chaulmoogra oil.

Which fatty materials are selected depends among other factors also on the specific end use to which the mixture according to the invention is to be put. For instance, the use of fish oils may be undesirable for the production of fancy leather goods because of the odor adhering to these fats.

Preference is given to fatty materials having iodine numbers of from about 30 to about 120 and especially from 40 to 85.

Examples of particularly preferred fatty materials are tallows of different origins, bone oil, neat's-foot oil, especially neat's-foot oil from cattle only, lard oil, triolein, rapeseed oil, olive oil, nut oil and castor oil.

The sulfitation products and oxidation products of the mono- or polyunsaturated fatty materials form as a result of the reaction of the olefinic double bonds present in the fatty materials with the sulfiting and/or oxidizing reagents. All or only some of the double bonds present in the fatty materials may enter the reaction.

Of particular use for the purposes of the invention are for example fish oil and rapeseed oil.

A relatively high degree of oxidation for the purposes of the present invention is present when Δd, the difference in the specific gravity of the oil or fat before and after oxidation, is in the range from 0.01 to 0.1 and preferably from 0.03 to 0.05.

A relatively low degree of sulfitation for the purposes of the present invention is present when the neutral oil has been reacted with from 2 to 8% and preferably with from 3 to 5% of its weight of a sulfite, reckoned as sodium bisulfite (Na₂S₂O₅).

Particular preference is thus given to fatliquoring compositions according to the invention that comprise one or more, modified or unmodified, native active components and/or optionally a synthetic, for example a polymeric, active component, emulsifiers and optionally diluents, especially water, and that contain one of the emulsifier compositions described above and wherein the active components comprise a relatively highly oxidized neutral oil having a relatively low degree of sulfitation.

The particularly preferred fatliquoring compositions of the invention generally contain from 80 to 98% by weight and preferably from 85 to 95% by weight of active components, with from 20 to 80% by weight and especially from 25 to 75% by weight of the active components being relatively highly oxidized neutral oils having a relatively low degree of sulfitation which are preferred for use according to the invention.

The fatliquoring compositions of the invention can be provided neat or, depending on user requirements, in the form of aqueous emulsions, advantageously having solids contents of from 40 to 80% by weight.

The components of the preferred fatliquoring compositions according to the invention, namely the emulsifier mixtures according to the invention and the neutral oils having a relatively high degree of oxidation and a relatively low degree of sulfitation, can be added separately in any order to the fatliquoring floats, as will be appreciated. The invention thus also provides a process for fatliquoring leather and hides by treatment with aqueous liquor floats containing fatliquors and emulsifiers, characterized by from 10 to 90% by weight and preferably 25-75% by weight of said fatliquors being relatively highly oxidized neutral oils having a relatively low degree of sulfitation and the float containing from 1 to 10% by weight and preferably from 2.5 to 7.5% by weight of an emulsifier composition according to the invention.

The invention further provides for the use of the subject emulsifier composition, preferably in combination with neutral oils having a relatively high degree of oxidation and a relatively low degree of sulfitation, in leather manufacture and also for the use of the subject emulsifier composition preferably in combination with neutral oils having a relatively high degree of oxidation and a relatively low degree of sulfitation for preparing fatliquoring compositions.

The use of the fatliquoring compositions according to the invention serves to soften the leather, to increase its fullness and strength and to protect it against moisture, dirt and outside chemical influences.

The presence in the leather treatment floats of the emulsifier compositions according to the invention leads to very good bath exhaustion and hence to particularly low COD values coupled with good attachment of the fatliquor ingredients in the interior of the leather and hence to low fogging values.

The examples which follow illustrate the invention.

### EXAMPLE 1

### Making an Emulsifier Preparation According to the Invention

180 kg of a C₁₀ alkanol ethoxylated with 7 AEO units,

200 kg of a C₁₆-C₁₈ fatty alcohol ethoxylated with 25 AEO units and 140 kg of a C₁₆-C₁₈ fatty alcohol ethoxylated with 80 AEO units are stirred together in a stirred vessel at from 60 to 80° C. until completely homogenized.

The preparation obtained is soluble in water. It can be used either directly or in the form of an aqueous dilution (40-80% by weight are convenient) in leather manufacture.

### EXAMPLE 2

### Leather Manufacture without Fatliquoring

100 parts by weight of chrome-tanned cattlehide leather from 2.0 to 2.2 mm in shaved thickness are introduced into 100 parts by weight of water at 40° C. and adjusted to pH 4.5 by addition of sodium formate and sodium bicarbonate. The leather is drummed at 40° C. for 60 minutes and then washed with 200 parts by weight of water.

This is followed by the addition of 100 parts by weight of water at 40° C. and 2 parts by weight of commercially available polymeric tanning material, 4 parts by weight of commercially available resin tanning material and 4 parts by weight of commercially available mimosa. After drumming for 90 minutes, the leather is dyed in the same float with 1 part by weight of a commercially available leather dye. The float is then dropped, 100 parts by weight of water are added and the leather is as usual drummed at 50° C. for 60 minutes.

The float is then adjusted to pH 3.5-3.8 with formic acid, and the leather is briefly rinsed cold and further processed as generally customary. A 20 ml sample of the float is then taken to determine COD. The leather obtained is well dyed, of minimal fullness and harsh.

The COD value of the float sample is determined in accordance with DIN 38409-H43-1 and the fogging value of the leather obtained is determined in accordance with DIN 75201 B. The results of these tests are collated in table 2.

### EXAMPLE 3

### Leather Manufacture with Fatliquoring, Conventional

100 parts by weight of chrometanned cattlehide leather from 2.0 to 2.2 mm in shaved thickness are introduced into 100 parts by weight of water at 40° C. and adjusted to pH 4.5 by addition of sodium formate and sodium bicarbonate. The leather is drummed at 40° C. for 60 minutes and then washed with 200 parts by weight of water.

This is followed by the addition of 100 parts by weight of water at 40° C. and 2 parts by weight of commercially available polymeric tanning material, 4 parts by weight of commercially available resin tanning material and 4 parts by weight of commercially available mimosa. After drumming for 90 minutes, the leather is dyed in the same float with 1 part by weight of a commercially available leather dye. The float is then dropped and the leather is admixed with 100 parts by weight of water and either 4 parts by weight of a commercially available lecithin fatliquor or 6 parts by weight of a fatliquoring agent mixture A and B of the composition reported in table 1 and drummed in this float at 50° C. for 60 minutes as usual.

The float is then adjusted to pH 3.5-3.8 with formic acid, and the leather is briefly rinsed cold and further processed as generally customary. A 20 ml sample of the float is then taken to determine COD. The leather obtained possesses very good color, a firm grain coupled with good fullness and average softness. The leather surface has a fatty hand. The COD value of the float sample taken at the end of the fatliquoring period is determined in accordance with DIN 38409-H43-1 and the fogging value of the leather obtained is determined in accordance with DIN 75201 B. The results of these tests are collated in table 2.

TABLE 1
Composition of fatliquors A and B
position

| | Commercially available | |
|---|---|---|
| Fat | lecithin fatliquor | Sulfite fatliquor |
| liquor | [% by weight] | [% by weight] |
| A | 33% by weight, based | Mixture of fish oil and rapeseed oil |
| | on fatliquor mixture | 40:60, air oxidized to Δd = 0.01 to 0.1, |
| | | * and reacted with 4% by weight (based |
| | | on oil mixture) of sodium disulfite |
| | | (Na₂S₂O₅) [67% by weight, based on |
| | | fatliquor mixture] |
| B | 33% by weight, based | Rapeseed oil, air oxidized to Δd = 0.01 |
| | on fatliquor mixture | to 0.05, * and reacted with 4% by |
| | | weight (based on oil mixture) of sodium |
| | | disulfite [67% by weight, based on |
| | | fatliquor mixture] |

* The extent of the air oxidation is characterized by the increase Δd in the specific gravity [g/ml].

### EXAMPLE 4

### Leather Manufacture with Fatliquoring, Inventive

Example 3 is repeated under the same conditions and using the same tanning materials and also the fatliquor mixtures A and B used there. However, in addition to the fatliquor mixtures, 5.2 parts by weight of the emulsifier preparation produced in example 1 are added to the float. The fatliquoring and further treatment of the leathers is continued exactly as described in example 3.

Thereafter, the COD values of the float sample and the fogging values of the leather produced are determined as in examples 2 and 3.

The leather produced has the same quality as that obtained according to example 3. The measured COD and fogging values obtained in examples 2 to 4 are collated in table 2.

TABLE 2

| Example No./ | COD | COD | Fogging | Fogging |
|---|---|---|---|---|
| (fatliquor) | [mg O₂/l] | relative [%] | [mg]* | [mg in %]* |
| Example 2, | 6200 | 78 | 1.8 | 42 |
| without | | | | |
| fatliquor | | | | |
| Example 3, | 7900 | 100 | 4.3 | 100 |
| just lecithin | | | | |
| fatliquor | | | | |
| Example 3, | 21200 | 268 | 4.60 | 107 |
| (fatliquor A) | | | | |
| Example 3, | 28200 | 357 | 3.2 | 74 |
| (fatliquor B) | | | | |
| Example 4, | 4900 | 62 | 4.25 | 99 |
| (fatliquor A) | | | | |
| Example 4, | 6100 | 77 | 3.10 | 72 |
| (fatliguor B) | | | | |

*Gravimetric determination

It can be seen that there is an enormous improvement in bath exhaustion (COD reduced by about 75%) coupled with reduced or unchanged fogging. This is remarkable in that normally a reduced COD leads to increased fogging.

1. An emulsifier composition comprising three components A, B and C wherein, said component A is a C₆ to C₁₄ alkanol alkoxylated with 4 to 12 AO units, or a mixture of a plurality of such alkanols,
said component B is a C₁₂-C₂₄ fatty alcohol mixture alkoxylated with 15 to 30 AO units, and
said component C is a C₁₂ to C₂₄ fatty alcohol mixture alkoxylated with 40 to 100 AO units.

2. An emulsifier composition as claimed in claim 1, wherein the weight fraction of
said component A is from 20 to 60% by weight,
said component B is from 20 to 70% by weight, and
said component C is from 10 to 50% by weight,
based on the total weight of the preparation.

3. An emulsifier composition as claimed in claim 1, wherein said component A is a C₈ to C₁₂ alkanol mixture alkoxylated with 4 to 12 AO units,
said component B is a C₁₄-C₂₀ fatty alcohol mixture alkoxylated with 15 to 30 AO units, and
said component C is a C₁₄ to C₂₀ fatty alcohol mixture alkoxylated with 40 to 100 AO units.

4. A fatliquoring composition for leather, comprising one or more, modified or unmodified, native active components with our without synthetic active components, emulsifiers and optionally diluents, especially water, containing an emulsifier composition as claimed in claim 1.

5. A fatliquoring composition as claimed in claim 4, wherein said active components include a relative highly oxidized neutral oil having a relatively low degree of sulfitation.

6-9. (canceled)

10. A process for fatliquoring leather and hides by treatment with aqueous liquor floats containing fatliquors and emulsifiers, characterized by from 10 to 90% by weight and preferably 25-75% by weight of said fatliquors being relatively highly oxidized neutral oils having a relatively low degree of sulfitation and the float containing from 1 to 10% by weight and preferably from 2.5 to 7.5% by weight of an emulsifier composition as claimed in claim 1.

11. A method for the manufacture of leather, comprising employment of the emulsifier composition of claim 1.

12. A method for preparing fatliquoring compositions, comprising employment of the emulsifier composition of claim 1.

13. A method for the manufacture of leather, comprising employment of the emulsifier composition of claim 1 in combination with relatively highly oxidized neutral oils having a relatively low degree of sulfitation.

14. A method for preparing fatliquoring compositions, comprising employment of the emulsifier composition of claim 1 in combination with relatively highly oxidized neutral oils having a relatively low degree of sulfitation.
